(19) United States
(12) Patent Application Publication
(10) Pub. No.: US 2010/0114463 A1
(43) Pub. Date: May 6, 2010

(54) System for cold starting machine

(75) Inventors: Matthew Edward Leustek, Metamora, IL (US); Nicholas Stephen Tegtmeyer, Indianapolis, IN (US); Michael Steven Bond, Chillicothe, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/289,583

(22) Filed: Oct. 30, 2008

(51) Int. Cl. F02D 45/00

(52) U.S. Cl. 701/113; 123/179.3

(57) ABSTRACT

A system for cold starting a machine is disclosed. The system may have an engine and a reductant tank. The system may also have a temperature sensor, which may be configured to generate a signal indicative of a temperature within the reductant tank. Additionally, the system may have a controller, which may be in communication with the engine and the temperature sensor. The controller may be configured to increase an operating temperature of the engine, based on the signal.

### TECHNICAL FIELD

The present disclosure relates generally to a system and, more particularly, to a system for cold starting a machine.

### BACKGROUND

Combustion engines, including diesel engines, and other engines known in the art, may exhaust a complex mixture of air pollutants, which may include nitrogen oxide (NOₓ). Due to heightened environmental concerns, exhaust emission standards for machines including combustion engines have become increasingly stringent. To comply with these emission standards, machine manufacturers sometimes equip machines with selective catalytic reduction (hereafter “SCR”) systems having reductant tanks. An SCR system reduces an amount of nitrogen oxide in an exhaust flow of a machine by injecting from a reductant tank a gaseous or liquid reductant (e.g., a mixture of urea and water) into the exhaust flow upstream of an SCR catalyst. Unfortunately, the reductant can freeze in the reductant tank, preventing the SCR system from injecting it into the exhaust flow, and causing the machine to fail to comply with the emission standards. For example, a mixture of urea and water can freeze at temperatures below approximately −11° C., which are frequently experienced by some machines operating in cold weather. Reductants stored in reductant tanks of these machines can freeze when the machines are shut down overnight. Although reductant is sometimes heated during operation of a machine, the reductant can remain frozen for unacceptably long periods of time when the machine is cold started (i.e., started when experiencing a low temperature), causing the machine to fail to comply with the emission standards.

One way to speed a thawing of a reductant is disclosed in U.S. Pat. No. 6,901,748 B2 (the '748 patent) issued to Gomulka on Jun. 7, 2005. The '748 patent discloses a diesel engine having an SCR system with a urea tank. The '748 patent also discloses a heater element, which is mounted to the urea tank for cold weather starts, and which is connected to a cord. An operator plugs the cord into an external power source to heat contents of the urea tank in anticipation of a cold weather start.

The disclosed method and systems are directed to overcoming one or more problems associated with the art.

### SUMMARY

In one aspect, the present disclosure is related to a system for cold starting a machine. The system may include an engine and a reductant tank. The system may also include a temperature sensor, which may be configured to generate a signal indicative of a temperature within the reductant tank. Additionally, the system may include a controller, which may be in communication with the engine and the temperature sensor. The controller may be configured to increase an operating temperature of the engine, based on the signal.

In another aspect, the present disclosure is related to a method of operating a machine. The method may include sensing a parameter indicative of a temperature of a reductant. The method may also include increasing an operating temperature of an engine of the machine based on the sensed parameter.

In yet another aspect, the present disclosure is related to a reductant heating system for a machine. The system may include an engine, which may include a cylinder. The engine may also include at least one exhaust valve, which may be associated with the cylinder. The at least one exhaust valve may be actuatable between an open position and a closed position. Additionally, the engine may include an engine passageway. The system may also include a reductant tank, which may include a tank passageway. The tank passageway may be in fluid communication with the engine passageway. Additionally, the system may include a temperature sensor, which may be configured to generate a signal indicative of a temperature within the reductant tank. The system may also include a controller, which may be in communication with the at least one exhaust valve and the temperature sensor. The controller may be configured to open the at least one exhaust valve during a power stroke of the cylinder, based on the signal.

### BRIEF DESCRIPTION OF THE DRAWINGS

FIG. 1 is a diagrammatic illustration of an exemplary disclosed reductant heating system including an exemplary disclosed combustion engine; and

FIG. 2 is a flow chart describing an exemplary method of operating the reductant heating system of FIG. 1.

### DETAILED DESCRIPTION

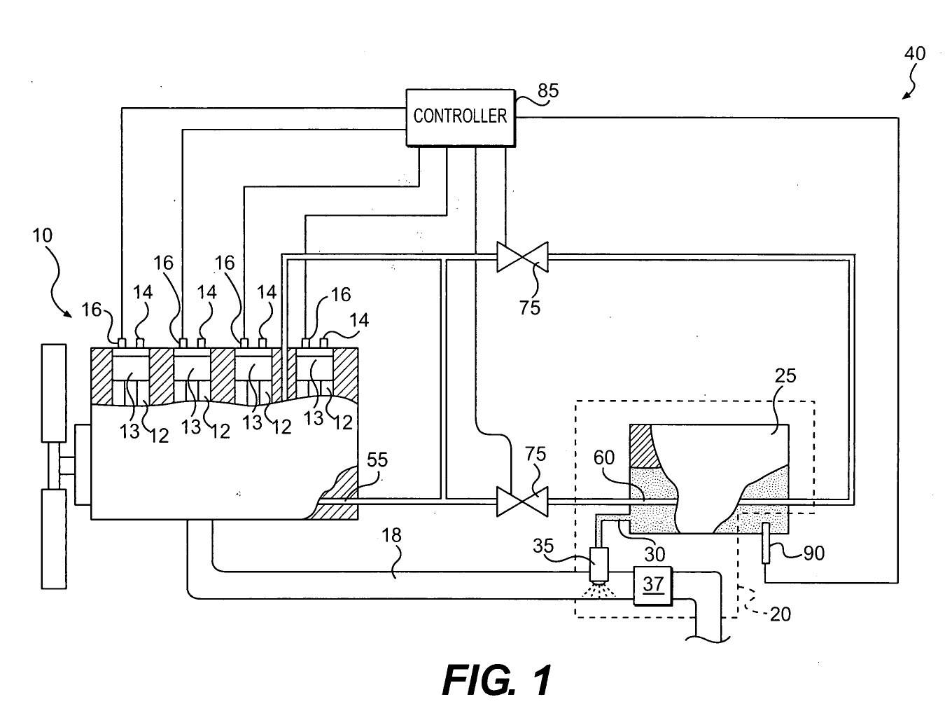

FIG. 1 illustrates a combustion engine 10 for a machine. For example, the machine may be a mobile machine that performs some type of operation associated with an industry such as mining, construction, farming, transportation, power generation, tree harvesting, forestry, recreation, or another industry known in the art.

Engine 10 may be an internal combustion engine, such as, for example, a diesel engine. Alternatively, engine 10 may be a gasoline engine, a gaseous fuel-powered engine, or another type of combustion engine known in the art. As illustrated in FIG. 1, engine 10 may have cylinders 12. Each cylinder 12 (hereafter “cylinder 12”) may be associated with a piston 13, at least one intake valve 14 (hereafter “intake valve 14”), and at least one exhaust valve 16 (hereafter “exhaust valve 16”). Intake valve 14 and exhaust valve 16 may be opened and closed (i.e., actuated) in accordance with a four stroke cycle of cylinder 12 of engine 10. These four strokes may include an intake stroke, a compression stroke, an expansion or power stroke, and an exhaust stroke. During the intake stroke (intake valve 14 open and exhaust valve 16 closed), piston 13 may move downward, sucking air and fuel into cylinder 12 through intake valve 14. Next, during the compression stroke (intake valve 14 closed and exhaust valve 16 closed), piston 13 may move upward, compressing the air and fuel within cylinder 12. Next, during the expansion or power stroke (intake valve 14 closed and exhaust valve 16 closed), the air and fuel within cylinder 12 may be combusted. This combustion may produce thermal energy, which may cause the combusted air and fuel to expand, powering downward movement of piston 13. Next, during the exhaust stroke (intake valve 14 closed and exhaust valve 16 open), piston 13 may move upward, exhausting the combusted air and fuel from cylinder 12 through exhaust valve 16.

Alternatively or additionally, intake valve 14 and exhaust valve 16 may be opened and closed irrespective of the four stroke cycle of cylinder 12. For example, exhaust valve 16 may be opened during the expansion or power stroke (hereafter the “power stroke”) of cylinder 12 of engine 10. In such a scenario, the combusted air and fuel within cylinder 12 may be exhausted from cylinder 12 before fully expanding. Thus, some of the thermal energy produced by the combustion of the air and fuel, which might otherwise power movement of piston 13, may cause an operating temperature of engine 10 to increase. Additionally, since movement of piston 13 may be insufficiently powered without this energy, more fuel may be used in subsequent intake strokes, increasing the thermal energy produced by subsequent combustions of air and fuel, and causing the operating temperature of engine 10 to increase further.

The combusted air and fuel exhausted from cylinder 12 (hereafter the “flow of exhaust”) may include several chemicals such as, for example, carbon monoxide, carbon dioxide, nitrogen oxide, ammonia, aldehyde(s), soot, oxygen, nitrogen, sulfur, water vapor, and/or hydrocarbons such as hydrogen and methane. Some of the chemicals may be subject to emission standards (i.e. subject to minimum and/or maximum allowable emission concentrations). Therefore, the flow of exhaust may be directed through an exhaust pipe 18 to an exhaust treatment device such as, for example, an SCR system 20.

SCR system 20 may include a reductant tank 25, which may or may not be located remotely from engine 10. For example, although engine 10 may be located within an engine compartment of the machine, reductant tank 25 may not be located within the engine compartment of the machine. Additionally, SCR system 20 may include a reductant pipe 30, an injector 35, and an SCR catalyst 37. A gaseous or liquid reductant may be stored within reductant tank 25. For example, the reductant may be a mixture of urea and water, and may freeze at temperatures below approximately −11° C. The reductant may flow from reductant tank 25 to injector 35 via reductant pipe 30. Injector 35 may inject the reductant into exhaust pipe 18 upstream of SCR catalyst 37 to reduce an amount of nitrogen oxide in the flow of exhaust. Unfortunately, the reductant can freeze in reductant tank 25, preventing injector 35 from injecting it into exhaust pipe 18. Therefore, the machine may include a reductant heating system 40 for thawing the reductant, and thereby allowing injector 35 to again inject the reductant into exhaust pipe 18. Although reductant heating system 40 may or may not operate independently of other systems of the machine, it should be understood that reductant heating system 40 may be a component of another system of the machine. For example, reductant heating system 40 may be a component of, and may operate in conjunction with, a system for cold starting the machine. The system for cold starting the machine may also include, for example, an engine block heater, an electric reductant heating system, a window defroster, and/or another component or system, which may be used to cold start the machine.

Reductant heating system 40 may thaw the reductant by transferring heat from engine 10 to the reductant. For example, heat may be transferred from engine 10 to the reductant via an engine coolant (e.g., water, antifreeze, or another type of engine coolant known in the art). The engine coolant may be circulated between an engine passageway 55 of engine 10 and a tank passageway 60 of reductant tank 25. In other words, there may be fluid communication between engine passageway 55 and tank passageway 60. The engine coolant may absorb heat from engine 10 as it flows through engine passageway 55, and may transfer heat to reductant tank 25 as it flows through tank passageway 60. Some of the heat transferred to reductant tank 25 may be transferred to the reductant, thawing the reductant.

In addition to engine 10 and reductant tank 25, reductant heating system 40 may include components for controlling the transfer of heat from engine 10 to the reductant. For example, reductant heating system 40 may include at least one coolant valve 75 (hereafter “coolant valve 75”), which may be situated to control the fluid communication between engine passageway 55 and tank passageway 60, and which may be actuatable between an open position and a closed position. When coolant valve 75 is open, coolant valve 75 may permit circulation of the engine coolant between engine passageway 55 and tank passageway 60. And, when coolant valve 75 is closed, coolant valve 75 may prevent circulation of the engine coolant between engine passageway 55 and tank passageway 60.

Reductant heating system 40 may also include a controller 85, which may include one or more processors (not shown) and one or more memory devices (not shown). Controller 85 may communicate with a temperature sensor 90 to determine a temperature of the reductant. In particular, temperature sensor 90 may sense a parameter indicative of a temperature within reductant tank 25, and may generate a signal indicative of this parameter. For example, the temperature within reductant tank 25 may be a temperature of the reductant. Therefore, the parameter indicative of the temperature within reductant tank 25 may also be indicative of the temperature of the reductant. Controller 85 may receive the signal, and may determine the temperature of the reductant based on the signal. Controller 85 may then communicate with exhaust valve 16 and/or coolant valve 75 to control the transfer of heat from engine 10 to the reductant, based on the determined temperature of the reductant. Specifically, controller 85 may open exhaust valve 16 during a power stroke of cylinder 12 of engine 10 to increase the operating temperature of engine 10, thereby allowing the engine coolant to absorb more heat from engine 10. Additionally, controller 85 may open coolant valve 75 to permit circulation of the engine coolant between engine passageway 55 and tank passageway 60. This may allow the engine coolant to transfer heat from engine 10 to reductant tank 25 and the reductant.

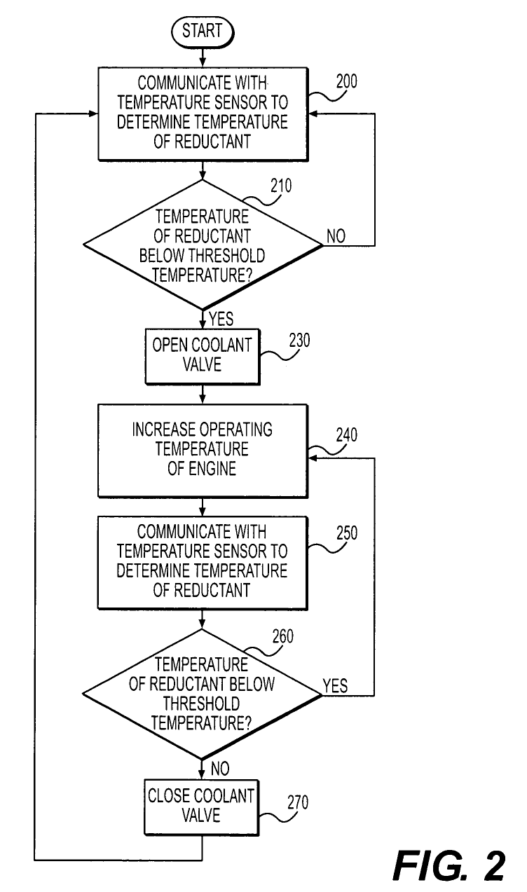

FIG. 2 illustrates an exemplary method of operating reductant heating system 40 of the machine. FIG. 2 will be discussed in the following section to further illustrate reductant heating system 40 and its operation.

### INDUSTRIAL APPLICABILITY

The disclosed reductant heating system may be applicable to mobile machines. The reductant heating system may be a component of a system for cold starting the mobile machines. In particular, the reductant heating system may thaw reductant stored within and used by a machine. Specifically, the reductant heating system may thaw the reductant by transferring heat from an engine of the machine to the reductant. Operation of the reductant heating system will now be described.

As illustrated in FIG. 2, reductant heating system 40, and more specifically, controller 85 (referring to FIG. 1), may communicate with temperature sensor 90 to determine the temperature of the reductant within reductant tank 25 (step 200). For example, controller 85 may receive from temperature sensor 90 a signal indicative of a parameter, which is indicative of the temperature within reductant tank 25. Controller 85 may then determine the temperature of the reductant based on this signal.

Next, controller 85 may compare the temperature of the reductant (determined during step 200) to a threshold temperature (step 210). The threshold temperature may be equivalent to a melting temperature of the reductant. For example, the threshold temperature may be approximately −11° C. Alternatively, the threshold temperature may be above a melting temperature of the reductant. If the temperature of the reductant (determined during step 200) is not below the threshold temperature, controller 85 may proceed to step 200 and again determine the temperature of the reductant.

Otherwise, controller 85 may open coolant valve 75 (step 230), thereby permitting fluid communication between engine passageway 55 and tank passageway 60, and permitting circulation of the engine coolant between engine passageway 55 and tank passageway 60. The engine coolant, which may absorb heat from engine 10 as it flows through engine passageway 55, may then transfer heat to reductant tank 25 as it flows through tank passageway 60. Some of this heat may be transferred to the reductant, thawing the reductant.

In order to increase the amount of heat absorbed by the engine coolant and transferred to the reductant, controller 85 may increase the operating temperature of engine 10 (step 240). Specifically, controller 85 may increase the operating temperature of engine 10 by opening exhaust valve 16 during a power stroke of cylinder 12 of engine 10. For example, controller 85 may open exhaust valve 16 between approximately 30 degrees and approximately 130 degrees after top dead center. Alternatively, controller 85 may increase the operating temperature of engine 10 using another method known in the art. For example, controller 85 may increase an amount of fuel supplied to engine 10.

Controller 85 may then again, as in step 200, communicate with temperature sensor 90 to determine the temperature of the reductant within reductant tank 25 (step 250). Next, controller 85 may, as in step 210, compare the temperature of the reductant (determined during step 250) to the threshold temperature (step 260). If the temperature of the reductant (determined during step 250) is below the threshold temperature, controller 85 may proceed to step 240 and again increase the operating temperature of engine 10. Otherwise, controller 85 may close coolant valve 75 (step 270), ceasing circulation of the engine coolant between engine passageway 55 and tank passageway 60, and preventing the engine coolant from transferring heat to reductant tank 25 and the reductant. Controller 85 may then proceed to step 200 and again determine the temperature of the reductant.

It is contemplated that reductant heating system 40 may speed thawing of the reductant when the machine is cold started. This speeding of the thawing of the reductant may be automatic, and may not require action by an operator of the machine. Specifically, controller 85 may determine, during step 210, that the temperature of the reductant is below the threshold temperature. Since the threshold temperature may be equivalent to the melting temperature of the reductant, this determination may mean that the reductant is frozen. Alternatively, if the threshold temperature is above the melting temperature of the reductant, the determination may mean that the reductant is colder than desired. In either case, controller 85 may open coolant valve 75 during step 230, based on the determination. The engine coolant may then circulate between engine passageway 55 and tank passageway 60. This circulation may allow the engine coolant to transfer heat from engine 10 to the reductant.

Although the transfer of heat from engine 10 to the reductant via the engine coolant may speed the thawing of the reductant, it is contemplated that controller 85 may further speed the thawing of the reductant by increasing the amount of heat transferred via the engine coolant. Controller 85 may accomplish this by increasing the operating temperature of engine 10 during step 240. Specifically, controller 85 may increase the operating temperature of engine 10 by opening exhaust valve 16 during a power stroke of cylinder 12 of engine 10.

While it may be desirable to transfer heat from engine 10 to the reductant during the thawing of the reductant, it is contemplated that transferring heat from engine 10 to the reductant once the reductant has thawed may be undesirable. Therefore, controller 85 may automatically stop transferring heat from engine 10 to the reductant. Specifically, controller 85 may determine, during step 260, that the temperature of the reductant is not below the threshold temperature. Since the threshold temperature may be equivalent to the melting temperature of the reductant or above the melting temperature of the reductant, this determination may mean that the reductant has thawed. Based on the determination, controller 85 may refrain from increasing the operating temperature of engine 10. Additionally, controller 85 may close coolant valve 75 during step 270.

It will be apparent to those skilled in the art that various modifications and variations can be made to the method and systems of the present disclosure. Other embodiments of the method and systems will be apparent to those skilled in the art from consideration of the specification and practice of the method and systems disclosed herein. It is intended that the specification and examples be considered as exemplary only, with a true scope of the disclosure being indicated by the following claims and their equivalents.

What is claimed is:

1. A system for cold starting a machine, the system comprising:
an engine;
a reductant tank;
a temperature sensor configured to generate a signal indicative of a temperature within the reductant tank; and
a controller in communication with the engine and the temperature sensor, the controller being configured to increase an operating temperature of the engine, based on the signal.

2. The system of claim 1, wherein:
the engine includes at least one exhaust valve, the at least one exhaust valve being actuatable between an open position and a closed position, and being associated with a cylinder of the engine;
the controller is in communication with the at least one exhaust valve; and
the controller is configured to increase the operating temperature of the engine by opening the at least one exhaust valve during a power stroke of the cylinder.

3. The system of claim 2, wherein the controller is configured to open the at least one exhaust valve during the power stroke of the cylinder between approximately 30 degrees and approximately 130 degrees after top dead center.

4. The system of claim 1, further comprising:
an engine passageway; and
a tank passageway, wherein the tank passageway and the engine passageway are in fluid communication.

5. The system of claim 4, further including at least one coolant valve situated to control fluid communication between the tank passageway and the engine passageway, wherein the controller is in communication with the at least one coolant valve, the controller being further configured to open the at least one coolant valve, based on the signal.

6. The system of claim 5, wherein the controller is further configured to close the at least one coolant valve, based on the signal.

7. The system of claim 1, wherein the controller is configured to increase the operating temperature of the engine if the signal indicates the temperature within the reductant tank is below a threshold temperature.

8. The system of claim 1, wherein the signal is indicative of a temperature of a reductant within the reductant tank.

9. A method of operating a machine, the method comprising:
sensing a parameter indicative of a temperature of a reductant; and
increasing an operating temperature of an engine of the machine based on the sensed parameter.

10. The method of claim 9, wherein increasing an operating temperature of the engine includes opening at least one exhaust valve of the engine during a power stroke of a cylinder of the engine.

11. The method of claim 10, wherein opening at least one exhaust valve during a power stroke of a cylinder of the engine includes opening at least one exhaust valve between approximately 30 degrees and approximately 130 degrees after top dead center.

12. The method of claim 9, further including circulating an engine coolant between the engine and a reductant tank based on the sensed parameter, the reductant being within the reductant tank.

13. The method of claim 12, further including ceasing to circulate the engine coolant between the engine and the reductant tank based on the sensed parameter

14. The method of claim 9, wherein increasing an operating temperature of the engine based on the sensed parameter includes increasing an operating temperature of the engine if the sensed parameter indicates the temperature of the reductant is below a threshold temperature.

15. The method of claim 14, wherein increasing an operating temperature of the engine based on the sensed parameter includes increasing an operating temperature of the engine if the sensed parameter indicates the temperature of the reductant is below a melting temperature of the reductant.

16. A reductant heating system for a machine, the reductant heating system comprising:
an engine including:
a cylinder;
at least one exhaust valve associated with the cylinder, the at least one exhaust valve being actuatable between an open position and a closed position; and
an engine passageway;
a reductant tank including a tank passageway, the tank passageway being in fluid communication with the engine passageway;
a temperature sensor configured to generate a signal indicative of a temperature within the reductant tank; and
a controller in communication with the at least one exhaust valve and the temperature sensor, the controller being configured to open the at least one exhaust valve during a power stroke of the cylinder, based on the signal.

17. The system of claim 16, wherein the controller is configured to open the at least one exhaust valve during the power stroke of the cylinder between approximately 30 degrees and approximately 130 degrees after top dead center.

18. The system of claim 16, wherein the controller is configured to open the at least one exhaust valve during the power stroke of the cylinder if the signal indicates the temperature within the reductant tank is below a threshold temperature.

19. The system of claim 16, further including at least one coolant valve situated to control fluid communication between the tank passageway and the engine passageway, wherein:
the controller is in communication with the at least one coolant valve; and
the controller is further configured to open the at least one coolant valve, based on the signal, to permit circulation of an engine coolant between the engine passageway and the tank passageway.

20. The system of claim 16, wherein the signal is indicative of a temperature of a reductant within the reductant tank.
